(19) United States
(12) Patent Application Publication
(10) Pub. No.: US 2007/0177343 A1
(43) Pub. Date: Aug. 2, 2007

(54) Portable personal computer

(76) Inventor: Ben Ming Hsia, Sun Valley, CA (US)

Correspondence Address: Raymond Y. Chan, Suite 128, 108 N. Ynez Avenue, Monterey Park, CA, 91754, US

(21) Appl. No.: 11/480,260

(22) Filed: Jun. 29, 2006

Related U.S. Application Data
(60) Provisional application No. 60/765,405, filed on Feb. 2, 2006.

(51) Int. Cl. G06F 1/16

(52) U.S. Cl. 361/683

(57) ABSTRACT

A portable personal computer includes a portable casing and computer components supported therein. The portable casing includes a first panel, a second panel, and an edge connector foldably coupling the first panel with the second panel edge-to-edge. The computer components includes a screen panel sealedly and overlappedly mounted on the first panel, a CPU circuitry sealedly mounted on the second panel to electrically connect to the screen panel, and a keyboard panel sealedly mounted on the second panel to electrically connect to the CPU circuitry. Therefore, the portable casing is adapted to fold at the storage position that the first panel is spacedly overlapped on the second panel to form a receiving cavity therebetween so as to protect the computer components in the receiving cavity, and at the usage position that the first panel is upwardly folded at an angle with respect to the second panel.

### CROSS-REFERENCE OF RELATED APPLICATION

This is a non-provisional application of a provisional application having an application No. 60/765,405 and a filing date of Feb. 2, 2006.

### BACKGROUND OF THE PRESENT INVENTION

1. Field of Invention

The present invention relates to computer, and more particularly to a portable personal computer which comprises a portable casing and a computer components supported therein not only to substantially reduce the overall manufacturing cost of the computer but also to allow the user to carry the computer without any carrying bag.

2. Description of Related Arts

A conventional notebook computer comprises a computer casing having a screen housing pivotally mounted to a main housing, a LCD screen mounted at the screen housing, and a control circuitry including a keyboard panel mounted at the main housing. However, such notebook computer has several drawbacks.

Since the notebook computer is very fragile, the user usually purchase a carrying case to carry the notebook computer. In other words, the carrying case becomes part of necessary components to protect the notebook computer. Even though the size of the notebook computer is compact, the user must carry the notebook computer with the carrying case everywhere. In addition, it is a hassle for the user to place the carrying case in a secure location for preventing the carrying case from being stolen while the notebook computer is being used.

Furthermore, in order to protect the notebook computer, the carrying case must have the cushion layer for absorbing an external impact force against the notebook computer when the notebook computer is received in the carrying case. Therefore, the overall weight of the carrying case will be substantially increased. It is unreasonable that the carrying case is heavier than the notebook computer while the weight of the notebook computer is about 2 lbs.

The cost of the notebook computer is extremely expensive because of the computer casing. The manufacturer must tailor make the screen housing and the main housing to fit the LCD screen and the keyboard panel.

In addition, the distance between the keyboard panel and the LCD screen is limited by the computer casing. Some notebook computers are used as a replacement of a desktop computer. However, the user should keep an optimum comfort distance between the eyes and the LCD screen while the keyboard panel will be far away from the user. Therefore, the user, especially for children, is suggested not to use such notebook computer which may hurt the eyes of the user if the notebook computer is placed closed to the user during the notebook computer is being used.

### SUMMARY OF THE PRESENT INVENTION

A main object of the present invention is to provide a portable personal computer which comprises a portable casing and a computer components supported therein not only to substantially reduce the overall manufacturing cost of the computer but also to allow the user to carry the computer without any carrying bag.

Another object of the present invention is to provide a portable personal computer, wherein a distance between the screen panel and the keyboard panel can be selectively adjusted via the portable casing. Therefore, the portable personal computer of the present invention can be considered as a replacement of the conventional desktop computer.

Another object of the present invention is to provide a portable personal computer, wherein the computer components, such as the screen panel and the keyboard panel, are sealedly mounted to the portable casing to minimize the overall size and weight of the portable personal computer, such that the user is able to easily carry the portable personal computer everywhere.

Another object of the present invention is to provide a portable personal computer, wherein the portable casing is adapted to fold into a storage position to protect the computer components for transportation and to fold into an usage position as a computer stand for the user to operate the computer components such that the portable casing provides multiple tasks to incorporate with the computer components.

Accordingly, in order to accomplish the above objects, the present invention provides a portable personal computer, comprising:

a portable casing comprising a first panel, a second panel, and an edge connector foldably coupling the first panel with the second panel edge-to-edge such that the portable casing is adapted to fold between a storage position and an usage position;

computer components comprising a screen panel sealedly and overlappedly mounted on the first panel, a CPU circuitry sealedly mounted on the second panel to electrically connect to the screen panel, and a keyboard panel sealedly mounted on the second panel to electrically connect to the CPU circuitry, wherein at the storage position, the first panel is spacedly overlapped on the second panel to form a receiving cavity therebetween so as to protect the computer components in the receiving cavity, and at the usage position, the first panel is upwardly folded at an angle with respect to the second panel to form a computer station to support the computer components; and

a support stand movably mounted at the first panel to retain the first panel at the angle so as to support the portable casing at the usage position.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of the portable personal computer at the storage position according to a preferred embodiment of the present invention.

FIG. 2 is a perspective view of the portable personal computer at the usage position according to the above preferred embodiment of the present invention, illustrating the support stand retaining the first panel in position.

FIG. 3 is a perspective view of the portable personal computer at the usage position according to the above preferred embodiment of the present invention.

FIGS. 4A to 4P illustrate the specification of the portable personal computer according to the above preferred embodiment of the present invention, showing the hardware implementation and the software implementation.

### DETAILED DESCRIPTION OF THE PREFERRED EMBODIMENT

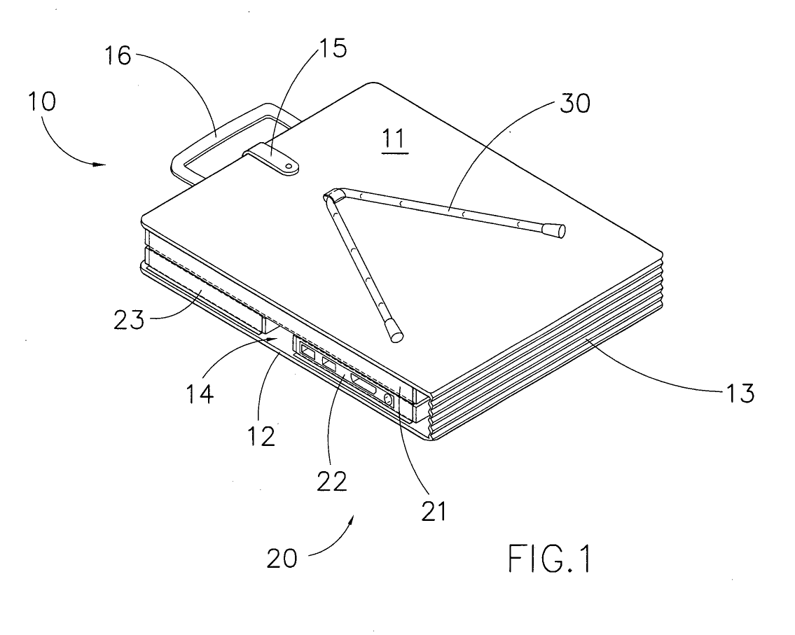

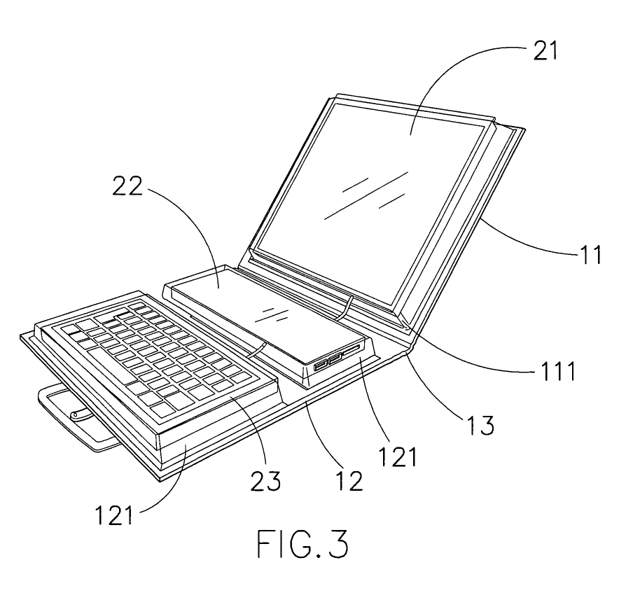

Referring to FIGS. 1 through 3 of the drawings, a portable personal computer according to a preferred embodiment of the present invention is illustrated, wherein the portable personal computer comprises a portable casing 10 and computer components 20.

The portable casing 10 comprises a first panel 11, a second panel 12, and an edge connector 13 foldably coupling the first panel 11 with the second panel 12 edge-to-edge such that the portable casing 10 is adapted to fold between a storage position and a usage position. The portable casing 10 further comprises a lock 15 to lock up the first and second panel 11, 12 at the storage position and a case handle 16 for the user to carry the portable casing 10.

The computer components 20 comprises a screen panel 21 sealedly and overlappedly mounted on the first panel 11, a CPU circuitry 22 sealedly mounted on the second panel 12 to electrically connect to the screen panel 21, and a keyboard panel 23 sealedly mounted on the second panel 12 to electrically connect to the CPU circuitry 22, wherein at the storage position, the first panel 11 is spacedly overlapped on the second panel 12 to form a receiving cavity 14 therebetween so as to protect the computer components 20 in the receiving cavity 14, and at the usage position, the first panel 11 is upwardly folded at an angle with respect to the second panel 12 to form a computer station to support the computer components.

According to the preferred embodiment, the portable casing 10 is made of durable but lightweight material such as plastic or fabric, to minimize the overall weight of the portable personal computer and to protect the computer components 20. The edge connector 13 is integrally extended between the first and second panels 11, 12. In other words, the portable casing 10 can be a sheet of plastic or fabric tri-folding to form the first panel 11, the second panel 12 and the edge connector 13. It is worth to mention that a cushion layer is preferably provided at the first and second panels 11, 12 to absorb the external impact force against the computer components 20 without substantially increasing the weight of the portable casing 10. Accordingly, the portable casing 10 can be made of any material fit for supporting the computer components 20.

According to the preferred embodiment, the computer components 20 are the bare bone components. In other words, the conventional computer components must have outer casing. For example, the conventional LED monitor comprises a screen housing to receive the screen panel and the conventional keyboard comprises a keyboard housing to receive the keyboard panel. However, the present invention omits all the housings of the conventional computer components that only the screen panel 21 and the keyboard panel 23 are used so as to substantially reduce the cost of the present invention. The installation is simple and easy that the user is able to install his or her computer by mounting the computer components 20 at the corresponding positions of the first and second panels 11, 12. It is worth to mention that the portable casing 10 can be replaced such that the user is able to change the portable casing 10 in low cost to keep the aesthetic appearance of the portable personal computer of the present invention.

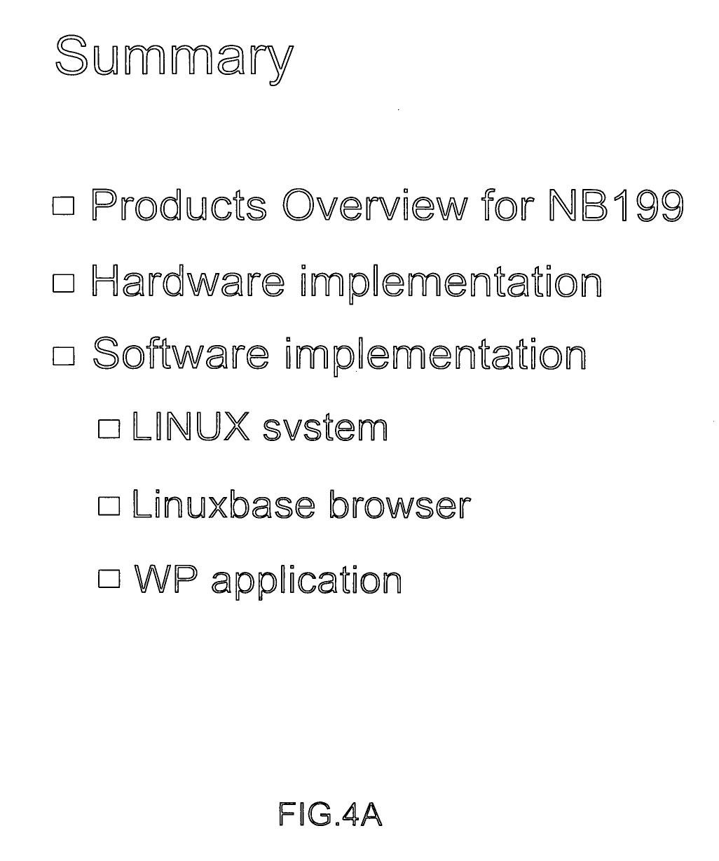

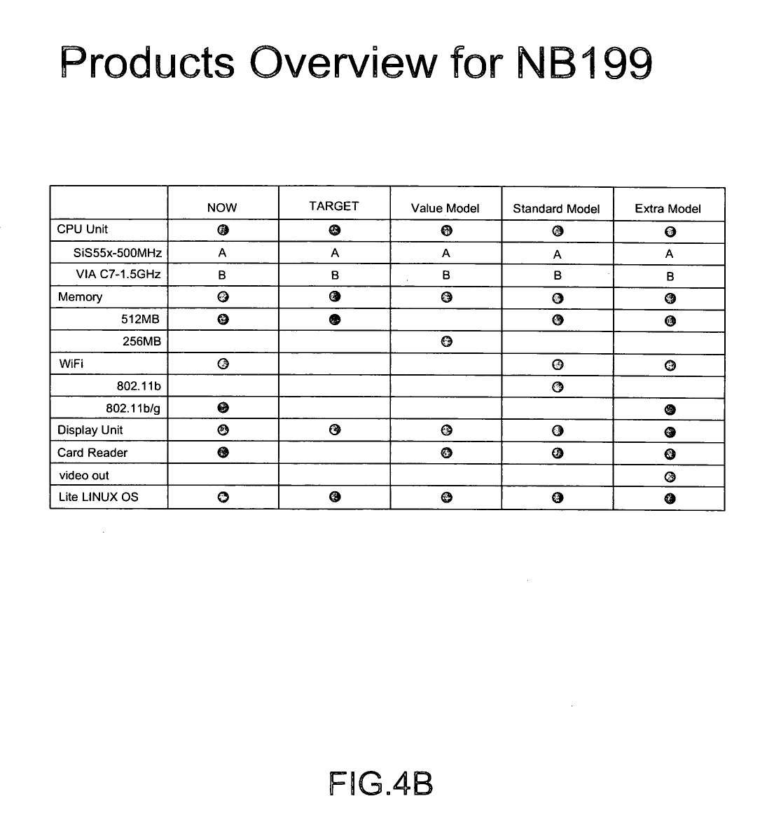

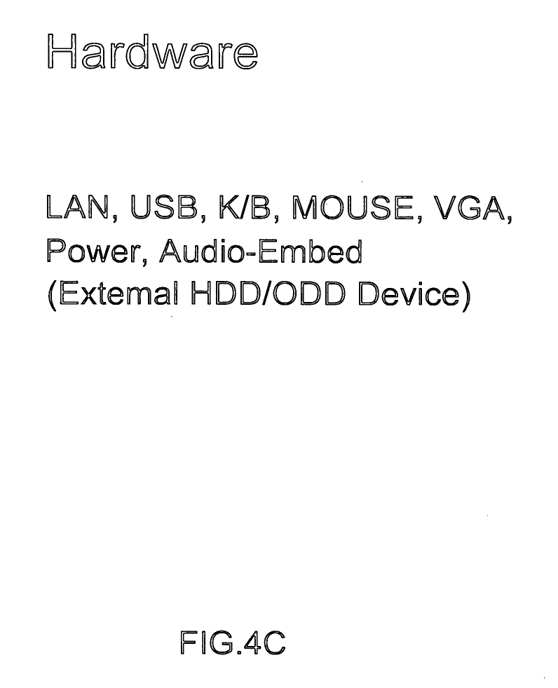

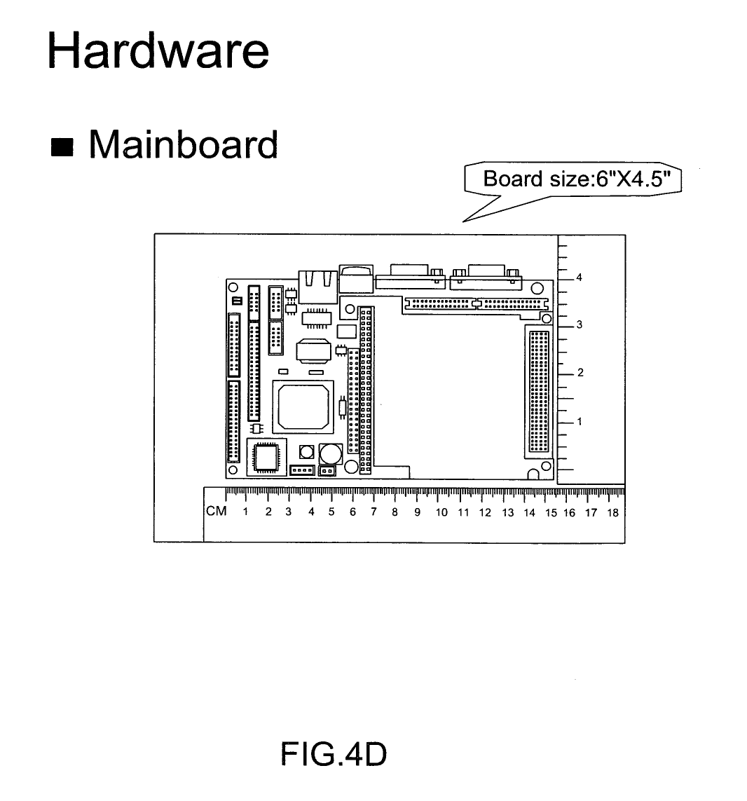

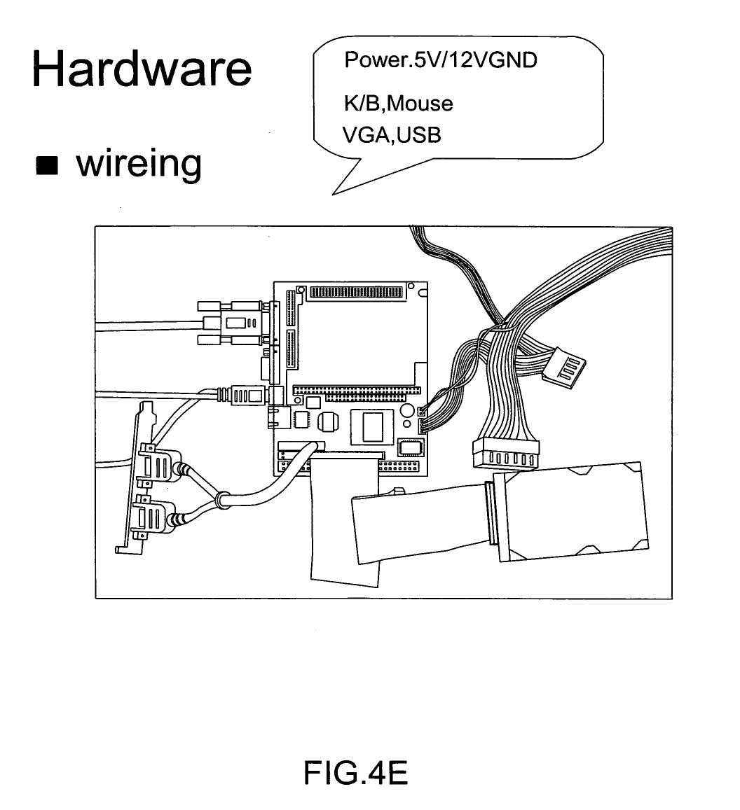

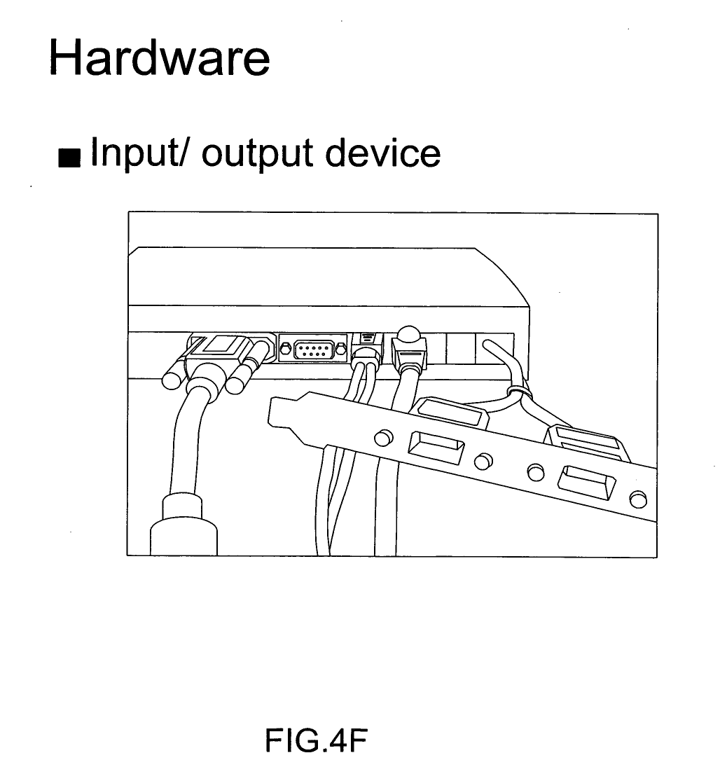

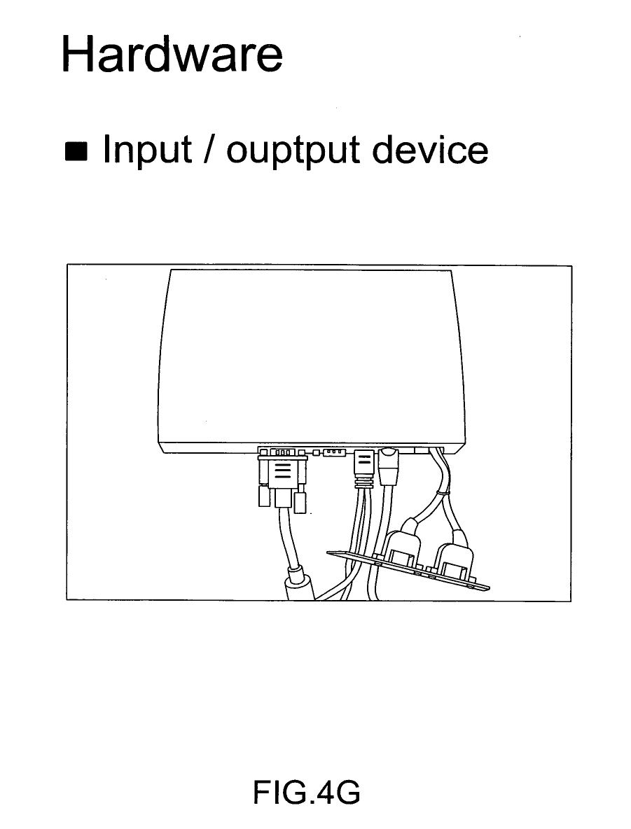

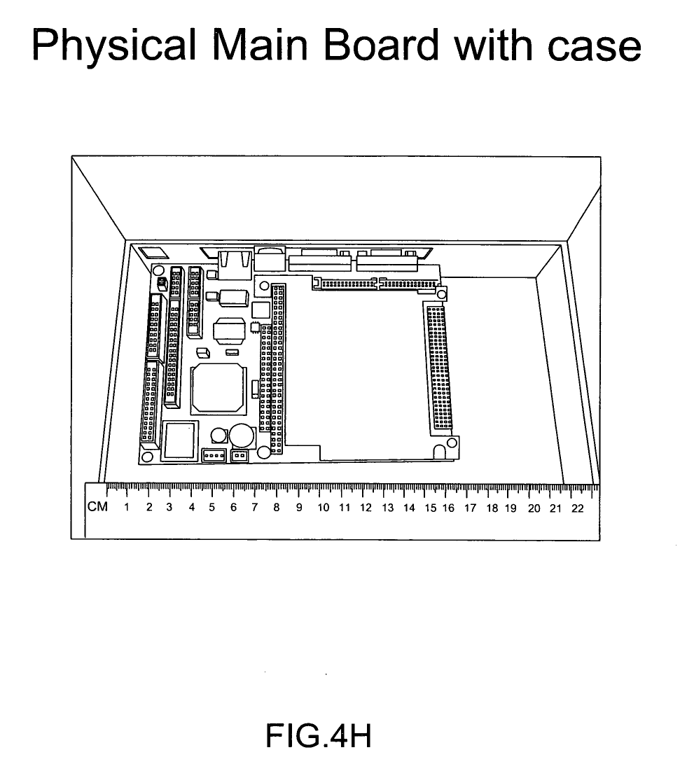

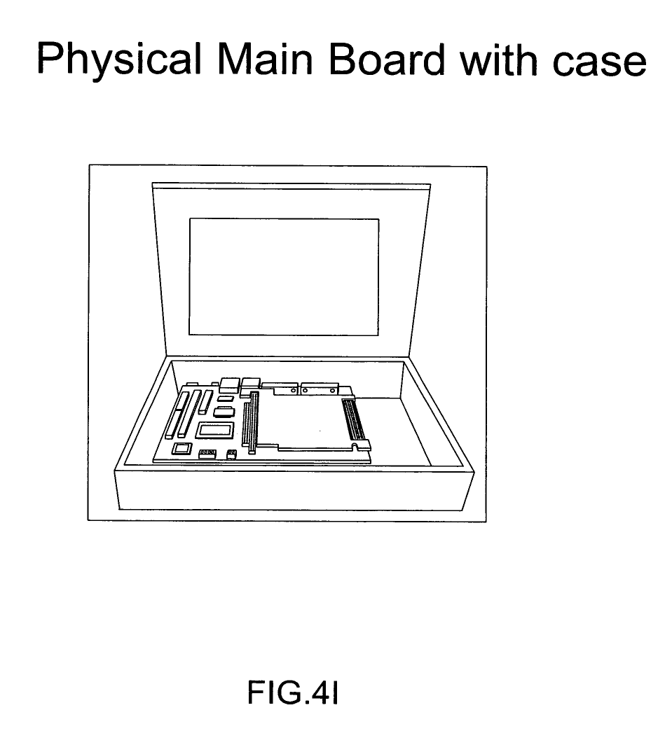

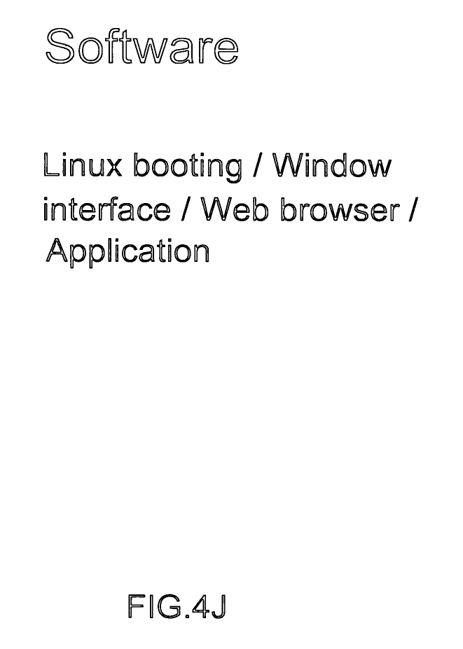

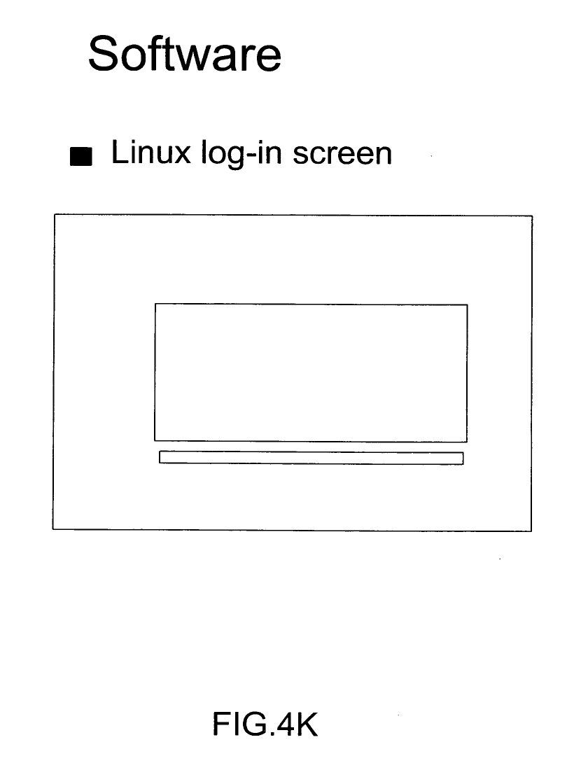

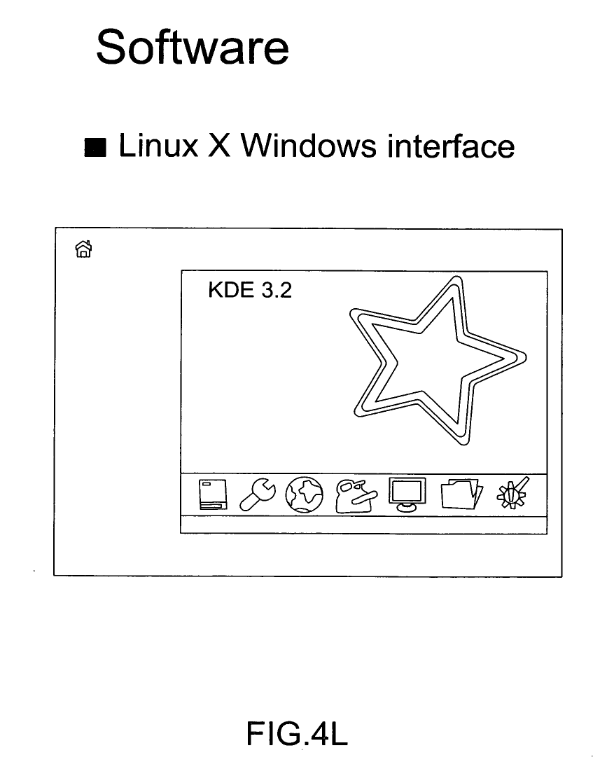

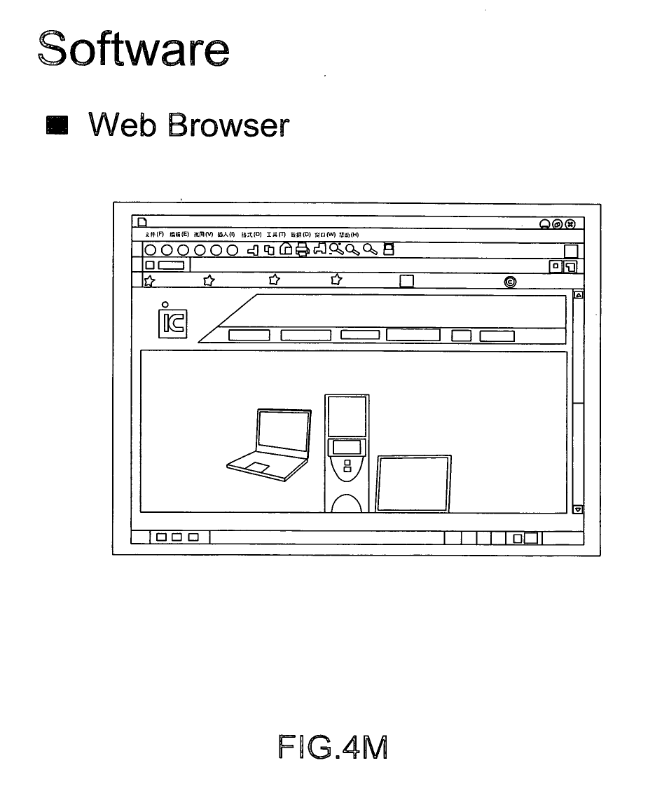

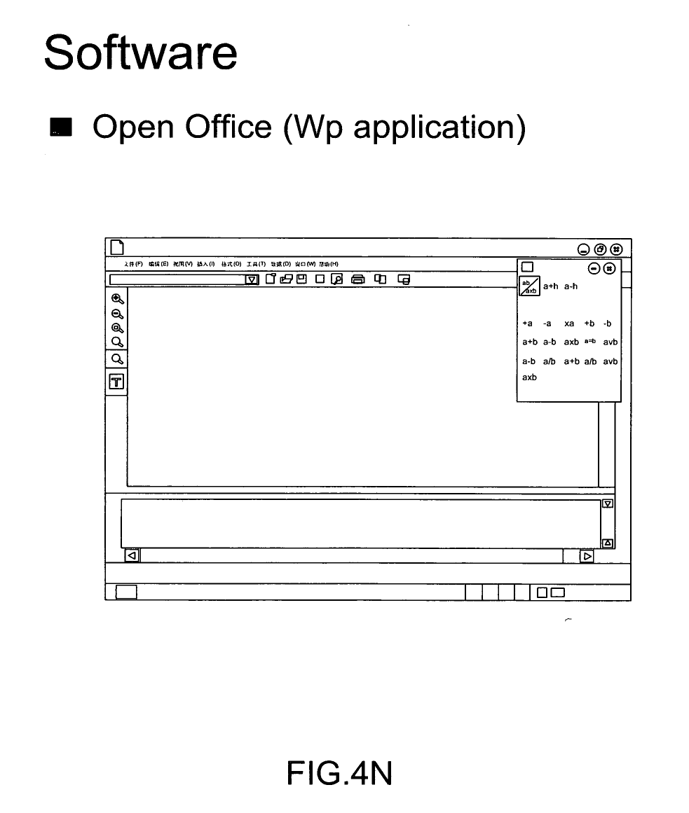

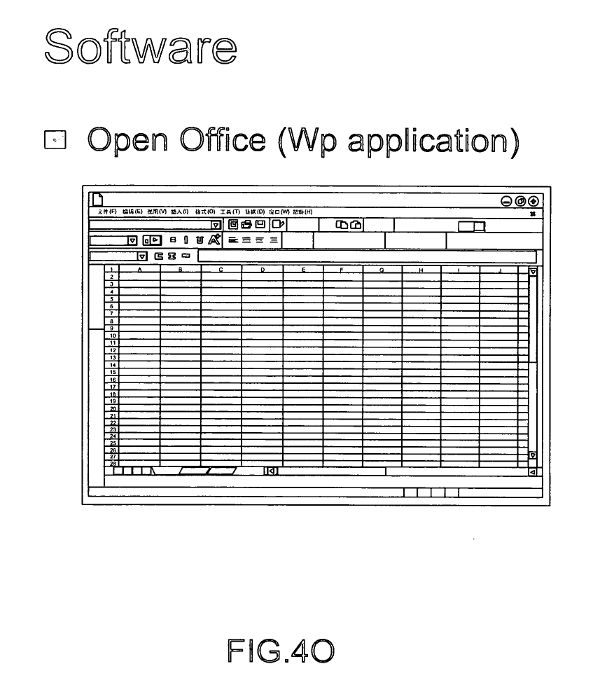

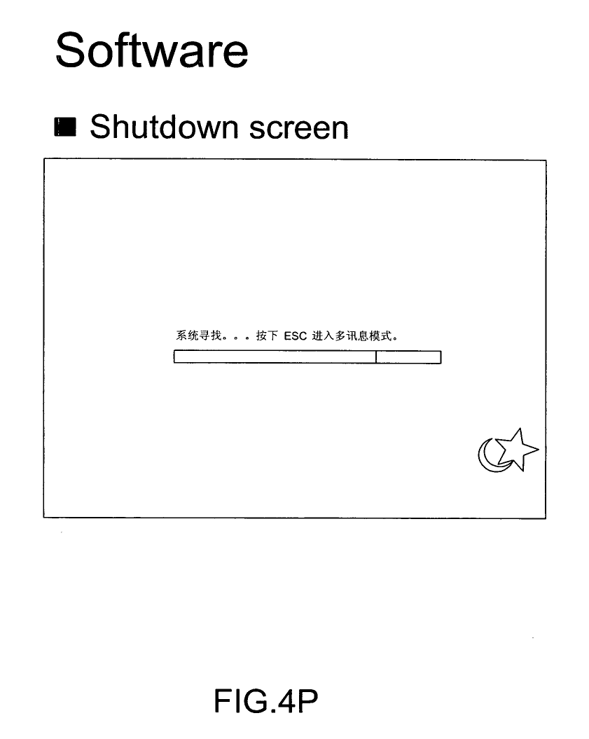

It is worth to mention that configuration of the computer components 20 is the same as the conventional computer components 20 as shown in FIGS. 4A to 4P including all the hardware implementation and software implementation.

The screen panel 21, which is a LCD screen panel, is sealedly mounted on the inner side of the first panel 11 to retain the screen panel 21 in position. The first panel 11 has a screen-sealing pocket 111 formed on the inner side of the first panel 11 to sealedly receive the screen panel 21 in the screen-sealing pocket 111. Alternatively, the surrounding edge of the screen panel 21 is sealed at the inner side of the first panel 11 to retain the screen panel 21 in position.

Likewise, the keyboard panel 23 is sealedly mounted on the inner side of the second panel 12 and the CPU circuitry 22 is sealed mounted on the inner side of the second panel 12 at the position between the screen panel 21 and the keyboard panel 23. The second panel 12 has two spaced apart sealing pockets 121 to sealedly receive the CPU circuitry 22 and the keyboard panel 23. It can be altered that the two sealing pockets 121 can be combined to form an integral pocket to receive the CPU circuitry 22 and the keyboard panel 23.

The CUP circuitry 23 comprises a CPU unit, computer memory, Ethernet card, and data input device such as card reader or USB port. Accordingly, the user is able to replace/upgrade the computer components 20 by simply wiring the computer components 20. Since the portable casing 10 can be formed in any size and shape, the user can change all the computer components 20 without the limitation of the casing, by simply placing the computer components 20 into the corresponding pockets and wiring them back to the original configuration.

The distance between the screen panel 21 and the keyboard panel 23 can be selectively adjusted by a width of the edge connector 13. The edge connector 13 can be made of fabric that allows the user to selectively locate the first panel 11 with respect to the second panel 12 via the edge connector 13. It is worth to mention that the first and second panels 11, 12 can be made of plastic and the edge connector 12 can be made of fabric to enhance the practice use of the present invention. For example, the edge connector 13 can be made of fabric having Z-shaped folding structure to allow the user to selectively pull the first panel 11 from the second panel 12 so as to selectively adjust the distance between the screen panel 21 and the keyboard panel 23.

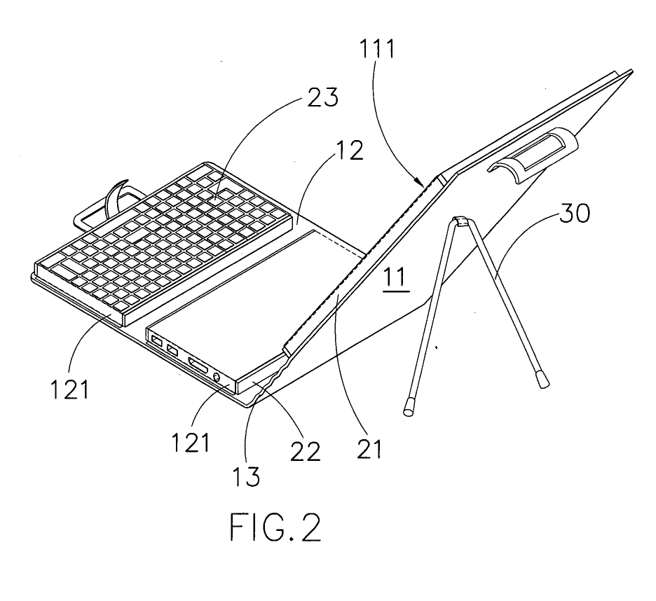

According to the preferred embodiment, the portable personal computer further comprises a support stand 30 movably mounted at the first panel 11 to retain the first panel 11 at the angle so as to support the portable casing 10 at the usage position. As shown in FIG. 2, the support stand 30 has an upper pivot end pivotally connected to the outer side of the first panel 11 and a ground end arranged when the pivot end of the support stand 30 is pivotally folded, the ground end of the support stand 30 stands at the supporting surface to retain the first panel 11 at the usage position.

The user is able to carry the portable personal computer by simply overlapedly folding the first panel 11 on the second panel 12 such that the portable casing 10 forms a carrying case to transport the computer components 20. For usage, the user is able to fold the first panel 11 from the second panel 12 so as to allow the user to access the computer components 20. Therefore, it is a hassle free for the user to place the carrying case in a secure place while using computer. It allows the user to carry the computer without any carrying bag. Due to the flexibility of the edge connector 13, the user is able to selectively adjust the distance between the screen panel 21 and the keyboard panel 23. Therefore, the portable personal computer of the present invention is considered as a replacement of the conventional desktop computer while the user is able to carry the desktop computer everywhere. In other words, the portable personal computer of the present invention provides not only the portability of the conventional notebook computer but also the practice use of the conventional desktop computer.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A portable personal computer, comprising:
a portable casing comprising a first panel, a second panel, and an edge connector foldably coupling the first panel with the second panel edge-to-edge such that the portable casing is adapted to fold between a storage position and an usage position;
computer components comprising a screen panel sealedly and overlappedly mounted on said first panel, a CPU circuitry sealedly mounted on said second panel to electrically connect to said screen panel, and a keyboard panel sealedly mounted on said second panel to electrically connect to said CPU circuitry, wherein at said storage position, said first panel is spacedly overlapped on said second panel to form a receiving cavity therebetween so as to protect said computer components in said receiving cavity, and at said usage position, said first panel is upwardly folded at an angle with respect to said second panel to form a computer station to support said computer components; and
a support stand movably mounted at said first panel to retain said first panel at said angle so as to support said portable casing at said usage position.

2. The portable personal computer, as recited in claim 1, wherein said edge connector is made of flexible material allowing said first panel being selectively located with respect to said second panel via a width of said edge connector so as to selectively adjust a distance between said screen panel and said keyboard panel.

3. The portable personal computer, as recited in claim 1, wherein said computer components are bare bone components of computer.

4. The portable personal computer, as recited in claim 2, wherein said computer components are bare bone components of computer.

5. The portable personal computer, as recited in claim 1, wherein said first panel has a screen-sealing pocket formed on an inner side of said first panel to sealedly receive said screen panel in said screen-sealing pocket, wherein said second panel has two spaced apart sealing pockets to sealedly receive said CPU circuitry and said keyboard panel.

6. The portable personal computer, as recited in claim 4, wherein said first panel has a screen-sealing pocket formed on an inner side of said first panel to sealedly receive said screen panel in said screen-sealing pocket, wherein said second panel has two spaced apart sealing pockets to sealedly receive said CPU circuitry and said keyboard panel.

7. The portable personal computer, as recited in claim 5, wherein said two sealing pockets at said second panel are combined to form an integral pocket to receive said CPU circuitry and said keyboard panel.

8. The portable personal computer, as recited in claim 6, wherein said two sealing pockets at said second panel are combined to form an integral pocket to receive said CPU circuitry and said keyboard panel.

9. The portable personal computer, as recited in claim 1, wherein a surrounding edge of said screen panel is sealed at an inner side of said first panel to retain said screen panel in position, wherein said second panel has two spaced apart sealing pockets to sealedly receive said CPU circuitry and said keyboard panel.

10. The portable personal computer, as recited in claim 4, wherein a surrounding edge of said screen panel is sealed at an inner side of said first panel to retain said screen panel in position, wherein said second panel has two spaced apart sealing pockets to sealedly receive said CPU circuitry and said keyboard panel.

11. The portable personal computer, as recited in claim 1, wherein said portable casing further comprises means for locking up said first and second panels at said storage position and a case handle extended from said portable casing for being carried, wherein said portable casing forms a carrying case when said first panel is overlapped with said second panel at said storage position.

12. The portable personal computer, as recited in claim 6, wherein said portable casing further comprises means for locking up said first and second panels at said storage position and a case handle extended from said portable casing for being carried, wherein said portable casing forms a carrying case when said first panel is overlapped with said second panel at said storage position.

13. The portable personal computer, as recited in claim 10, wherein said portable casing further comprises means for locking up said first and second panels at said storage position and a case handle extended from said portable casing for being carried, wherein said portable casing forms a carrying case when said first panel is overlapped with said second panel at said storage position.

14. The portable personal computer, as recited in claim 1, wherein said support stand has an upper pivot end pivotally connected to an outer side of said first panel and a ground end arranged when said pivot end of said support stand is pivotally folded, said ground end of said support stand adapted for standing at a supporting surface to retain said first panel at the usage position.

15. The portable personal computer, as recited in claim 12, wherein said support stand has an upper pivot end pivotally connected to an outer side of said first panel and a ground end arranged when said pivot end of said support stand is pivotally folded, said ground end of said support stand adapted for standing at a supporting surface to retain said first panel at the usage position.

16. The portable personal computer, as recited in claim 13, wherein said support stand has an upper pivot end pivotally connected to an outer side of said first panel and a ground end arranged when said pivot end of said support stand is pivotally folded, said ground end of said support stand adapted for standing at a supporting surface to retain said first panel at the usage position.

17. The portable personal computer, as recited in claim 1, wherein said portable casing, which is made of fabric to minimize an overall weight of said portable personal computer, comprises a cushion layer provided at each of said first and second panels for absorbing an external impact force against said computer components so as to protect said computer components.

18. The portable personal computer, as recited in claim 4, wherein said portable casing, which is made of fabric to minimize an overall weight of said portable personal computer, comprises a cushion layer provided at each of said first and second panels for absorbing an external impact force against said computer components so as to protect said computer components.

19. The portable personal computer, as recited in claim 16, wherein said portable casing, which is made of fabric to minimize an overall weight of said portable personal computer, comprises a cushion layer provided at each of said first and second panels for absorbing an external impact force against said computer components so as to protect said computer components.

20. The portable personal computer, as recited in claim 15, wherein said portable casing, which is made of fabric to minimize an overall weight of said portable personal computer, comprises a cushion layer provided at each of said first and second panels for absorbing an external impact force against said computer components so as to protect said computer components.
